(19) United States
(12) Patent Application Publication
(10) Pub. No.: US 2008/0141225 A1
(43) Pub. Date: Jun. 12, 2008

(54) METHOD FOR MIGRATING FILES

(76) Inventors: James E. Bostick, Cedar Park, TX (US); Brian W. Hansen, Round Rock, TX (US); Raghuraman Kalyanaraman, Austin, TX (US)

Correspondence Address: IBM CORPORATION (RUS);c/o Rudolf O Siegesmund Gordon & Rees, LLp, 2100 Ross Avenue, Suite 2800, DALLAS, TX, 75201, US

(21) Appl. No.: 11/567,348

(22) Filed: Dec. 6, 2006

(51) Int. Cl. G06F 9/44

(52) U.S. Cl. 717/128

(57) ABSTRACT

A “File Updater” adds an additional feature to the Classpath Identifier that automatically displays a JAR file in a first environment, and copies the JAR file from the first environment to a second environment whenever a required JAR file is missing in the second environment, or if the required JAR file in the second environment is missing a component.

### CROSS-REFERENCE TO RELATED APPLICATION

The present invention is related to the subject matter of U.S. patent application Ser. No. ______ (Attorney Docket number AUS90060763US1), incorporated herein by reference.

### FIELD OF THE INVENTION

The present invention relates generally to data processing systems and relates specifically to migrating missing files using a help dialog box of a software debugger.

### BACKGROUND OF THE INVENTION

Software developers migrate computer applications from a first environment to a second environment in the normal course of their work. For example, when software developers complete a new computer application, they must migrate the new computer application from a development environment to a work environment where the application can be used by others. In another example, existing applications are migrated from a first environment on an old server or computer running an old operating system to a second environment on new server or a computer running new operating system. Even when a computer application runs properly in a first environment, errors may occur when running the computer application in a second environment.

In order to prevent errors, software developers test, or “debug,” the computer application in the second computer environment to verify that the computer application runs properly in the second environment. To test the computer application in the second environment, software developers use a debugger. Debuggers run each line of code in the computer application in sequence, one line of code at a time, to identify any errors that may occur for each line of code. Debuggers often employ a feature called a help dialog box to assist in the debugging process. A help dialog box contains additional information about an element on a computer display in response to the user performing a predefined action related to the element. For example, a help dialog box may open when a user right clicks on the element, or selects “help” from a menu when the element is highlighted. In another example, “Hover help” is a help dialog box that opens when a user places a mouse cursor over the element. U.S. Patent. App. No. 2005/0114778 A1 discloses hover help for displaying information in response to a mouse cursor positioned over a feature on a computer display. In the context of a debugger, hover help displays information about a line of code when the developer places a mouse cursor over the line of code. A debugger's help dialog box information may describe the usage of a command in the line of code, the types of arguments that can be used with the command, and the types of responses that can be generated by the command.

JAVA is a programming language used by software developers to create computer applications. JAVA computer applications are often made up of several partial computer applications called “Applets.” Each Applet used by a JAVA computer application can be stored and run from separate physical or logical locations. For example, an Applet on a server computer and an Applet on a client computer can run together as part of a single JAVA computer application. Because portions of a JAVA computer application can be run on separate computers, the JAVA programming language is particularly well suited for internet based computer applications used on the World Wide Web.

In order to run Applets located on different computers together in a single JAVA computer application, the JAVA programming language employs a structure for defining and locating each Applet used by a JAVA computer application. The structure employs “classpaths” and import statements to tell a JAVA compiler where to locate Applets used by a JAVA computer application. A classpath is a JAVA environment variable that tells a JAVA compiler where to find one or more “class files.” A “class file” is a complied JAVA source code for a JAVA computer application or Applet, using a precisely defined file format. Class files are stored in a “JAR file” (JAR is an abbreviation of “JAVA Archive”) bundled with associated auxiliary resources containing everything needed for a single JAVA computer application or Applet to run. JAVA compilers use an “import statement” to locate related resources and class files using a fully qualified class name. Alternatively, software developers can define a set of import statements to list each individual resource and class file related to a common classpath. Software developers must be careful to ensure that the classpath and import statements are correct, or else the JAVA computer application will not be able to locate JAR files containing the class files for the Applets that make up the JAVA computer application.

When migrating JAVA computer applications from a first environment to a second environment, software developers encounter three common errors. Either a classpath is not set up properly for the second environment, contents are missing from a required JAR file, or a required JAR file is missing. With any of these errors, the JAVA computer application cannot locate the required JAR file or JAR file contents. If the classpath is not set up correctly, the JAVA compiler will not look for class files in the correct location. If some of contents of the required JAR file are missing, such as an instruction set or resource, the JAVA compiler will not be able to locate or run the required JAR file contents. If the required JAR file containing the class file was not copied to the second environment, or if the required JAR file was not copied to the proper directory in the second environment, then the JAVA compiler will not be able to locate the required JAR file.

U.S. patent application Ser. No. ______ (Attorney Docket number AUS90060763US1) disclose a Classpath Identifier help dialog box plug-in that obtains the classpath for a selected line of code from the JAVA compiler and displays the current classpath when using a JAVA debugger. (The classpath is identified by the JAVA compiler as part of the compiling process prior to debugging the JAVA computer application.) Additionally, the Classpath Identifier displays the name and location of the JAR file containing the line of code. Although the Classpath Identifier helps developers quickly identify and correct errors when a JAVA computer application works in a first environment but not in a second environment, a need exists for a way to automatically copy a JAR file from the first environment to the second environment when a required JAR file in the second environment is missing or the required JAR file in the second environment is missing a component.

### SUMMARY OF THE INVENTION

A “File Updater” adds an additional feature to the Classpath Identifier help dialog box plug-in that displays a JAR file in a first environment, and automatically copies the JAR file from the first environment to a second environment whenever a required JAR file is missing in the second environment, or whenever the required JAR file in the second environment is missing a component.

### BRIEF DESCRIPTION OF DRAWINGS

The novel features believed characteristic of the invention are set forth in the appended claims. The invention itself, however, as well as a preferred mode of use, further objectives and advantages thereof, will be understood best by reference to the following detailed description of an illustrative embodiment when read in conjunction with the accompanying drawings, wherein:

FIG. 1 is an exemplary computer network;

FIG. 2 describes programs and files in a memory on a computer;

FIG. 3 is a flowchart of a hover help plug-in; and

FIG. 4 is a flowchart of a migration component.

### DETAILED DESCRIPTION OF THE PREFERRED EMBODIMENT

The principles of the present invention are applicable to a variety of computer hardware and software configurations. The term “environment,” “computer hardware,” or “hardware,” as used herein, refers to any machine or apparatus that is capable of accepting, performing logic operations on, storing, or displaying data, and includes without limitation processors and memory. An “environment” may refer to a physical or logical partition of computer hardware. The term “computer software” or “software,” refers to any set of instructions operable to cause computer hardware to perform an operation. A “computer,” as that term is used herein, includes without limitation any useful combination of hardware and software, and a “computer program” or “program” includes without limitation any software operable to cause computer hardware to accept, perform logic operations on, store, or display data. A computer program may, and often is, comprised of a plurality of smaller programming units, including without limitation subroutines, modules, functions, methods, and procedures. Thus, the functions of the present invention may be distributed among a plurality of computers and computer programs. The invention is described best, though, as a single computer program on a second environment that configures and enables one or more general-purpose computers to implement the novel aspects of the invention, including copying files from a first environment to the second environment. For illustrative purposes, the inventive computer program will be referred to as the “File Updater.”

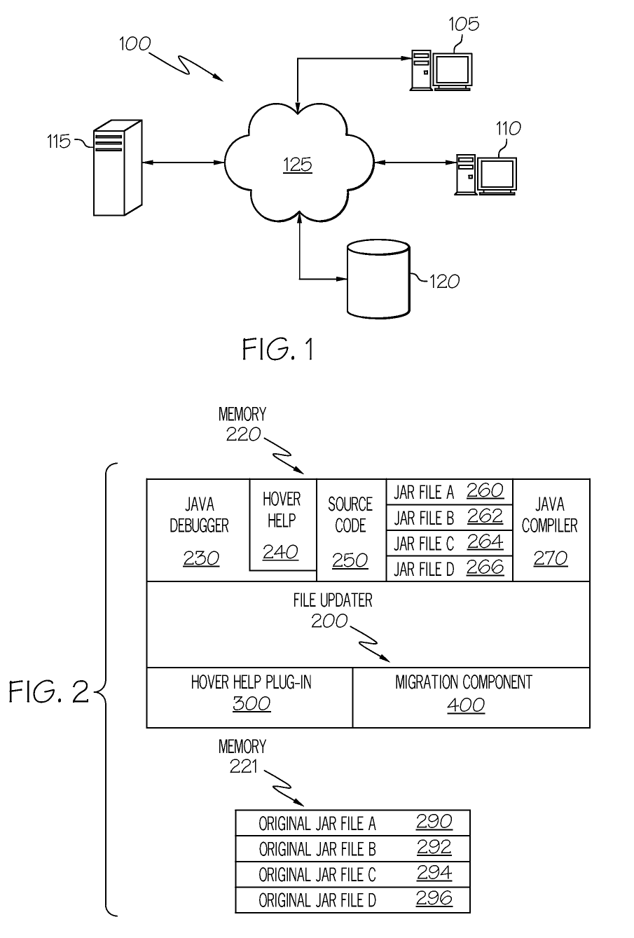

Additionally, the File Updater is described below with reference to an exemplary network of hardware devices, as depicted in FIG. 1. A “network” comprises any number of hardware devices coupled to and in communication with each other through a communications medium, such as the Internet. A “communications medium” includes without limitation any physical, optical, electromagnetic, or other medium through which hardware or software can transmit data. For descriptive purposes, exemplary network 100 has only a limited number of nodes, including workstation computer 105, workstation computer 110, server computer 115, and persistent storage 120. Network connection 125 comprises all hardware, software, and communications media necessary to enable communication between network nodes 105-120. Unless otherwise indicated in context below, all network nodes use publicly available protocols or messaging services to communicate with each other through network connection 125.

File Updater 200 typically is stored in a memory in a second environment, represented schematically as memory 220 in FIG. 2. The term “memory,” as used herein, includes without limitation any volatile or persistent medium, such as an electrical circuit, magnetic disk, or optical disk, in which a computer can store data or software for any duration. A single memory may encompass and be distributed across a plurality of media. Further File Updater 200 may reside in more than one memory distributed across different computers, servers, logical partitions, or other hardware devices. The elements depicted in memory 220 may be located in or distributed across separate memories in any combination, and File Updater 200 may be adapted to identify, locate and access any of the elements and coordinate actions, if any, by the distributed elements. Thus, FIG. 2 is included merely as a descriptive expedient and does not necessarily reflect any particular physical embodiment of memory 220. As depicted in FIG. 2, though, memory 220 may include additional data and programs. Of particular import to File Updater 200, memory 220 may include JAVA debugger 230, source code 250, JAR file A 260, JAR file B 262, JAR file C 264, JAR file D 266, and JAVA compiler 270 with which File Updater 200 interacts. JAVA debugger 230 incorporates existing art component hover help 240. File Updater 200 has two component, hover help plug-in 300 and migration component 400.

Memory 221 is located in a first environment. Memory 221 may include original JAR file A 290, original JAR file B 292, original JAR file C 294, original JAR file D 296. In a preferred embodiment, a developer has already migrated source code 250 from the first environment shown by memory 221 to the second environment shown by memory 220. The developer uses File Updater 200 when running JAVA debugger 230 to verify that source code 250 operates properly in the second environment.

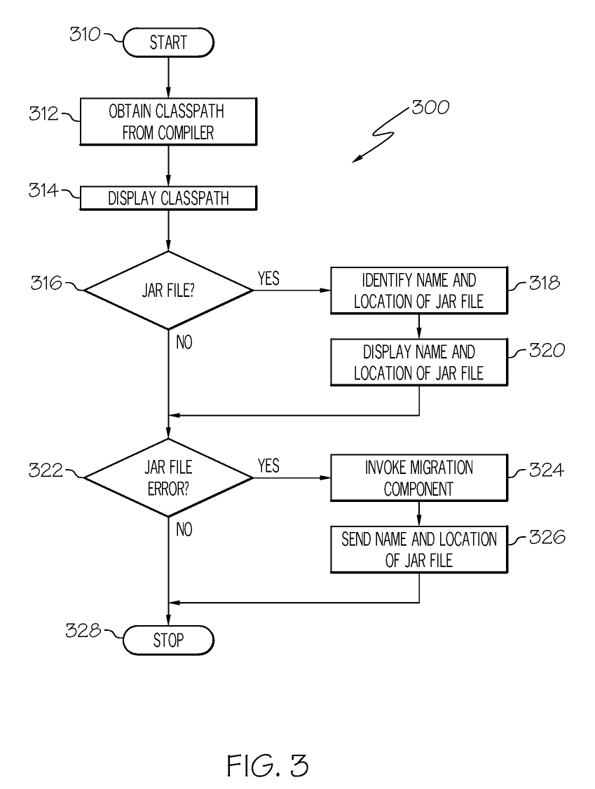

Hover help plug-in 300, shown in FIG. 3, starts whenever a user of JAVA debugger 230 activates hover help 240 (310). Hover help 240 is generally activated whenever a software developer places a mouse cursor over a selected line of code in source code 250 while debugging source code 250 with debugger 230. Hover help plug-in 300 obtains the classpath related to the selected line of code in source code 250 from JAVA compiler 270 (312). 250 when source code 250 was compiled as part of or prior to the debugging process. Hover help plug-in 300 displays the classpath in the hover help dialog box (314). Hover help plug-in 300 determines if the selected line of code in source code 250 is located in a JAR file, such as JAR file A 260 (316). Hover help plug-in 300 determines whether the selected line of code is located in a JAR file by referencing information available from JAVA compiler 270. If the selected line of code is located in a JAR file, such as JAR file A 260, hover help plug-in 300 identifies the name and location of JAR file 260 (318) and displays the name and location of JAR file A 260 in the hover help dialog box (320). After displaying the classpath and JAR file, hover help plug-in 300 determines if there is an error with JAR file A 260. An error may occurs when JAR file A 260 is missing from the proper location, or when JAR file A 260 is missing a component (322). If there is an error with JAR file A 260, hover help plug-in invokes migration component 400 (324) and sends the name and proper location of JAR file A 260 to migration component 400 (326). If there are no errors with JAR file A 260, or after initiating migration component 400, hover help plug-in stops (328).

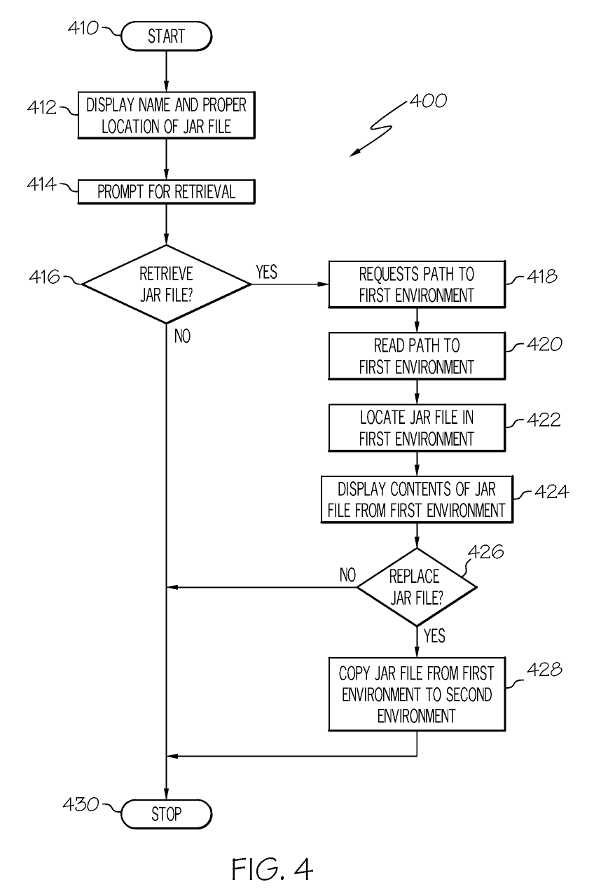

Migration component 400, as shown in FIG. 4, starts when invoked by hover help plug-in 300 (410). Migration component 400 displays the name and proper location of JAR file A 260 (412). Migration component 400 prompts the developer, asking if the developer wants to retrieve a copy JAR file A 260 (original JAR file A 290) from the first environment (414). If the developer wants to retrieve a copy of original JAR file A 290 (416), migration component 400 requests that the developer specify or confirm the path to the first environment (418). Migration component 400 reads the path to the first environment (420), and locates original JAR file A 290 in the first environment, represented as memory 221 (422). After locating original JAR file A 290 in the first environment, migration component 400 displays the contents of original JAR file A 290 from the first environment (424). If the developer wants to replace JAR file A 260 with original JAR file A 290, migration component 400 copies original JAR file A 290 from memory 221 and saves JAR file A 290 to memory 220, replacing JAR file A 260 (428). After migrating the JAR file, or if the developer chooses not to retrieve or replace the JAR file, migration component 400 stops (430).

A preferred form of the invention has been shown in the drawings and described above, but variations in the preferred form will be apparent to those skilled in the art. One skilled in the art will see that the File Updater can be applied to the migration of many different types of applications from a first environment to a second environment using any IDE (Integration Developer Environment). In addition to JAVA applets, the File Updater can by used with servlets, weblets, and non-JAVA based applications and sub-applications. Further, File Updater Identifier can be used with any help dialog box implementation known in the art, not just hover help. The preceding description is for illustration purposes only, and the invention should not be construed as limited to the specific form shown and described. The scope of the invention should be limited only by the language of the following claims.

What is claimed is:

1. A computer implemented process for migrating a file associated with a line of computer code, the computer implemented process comprising:
responsive to a help dialog box related to a line of code being activated in an IDE, performing the steps of:
identifying a name and a location of a JAR file containing the line of code;
displaying the name and the location of the JAR file in the help dialog box;
determining if the JAR file is causing an error;
responsive to determining that the JAR file is causing the error, locating an original source of the JAR file;
displaying the contents of the original source of the JAR file; and
replacing the JAR file causing the error with a copy of the original source of the JAR file.

2. The computer implemented process of claim 1 wherein:
the JAR file is in a second computer environment; and
the original source of the JAR file is in a first computer environment.

3. The computer implemented process of claim 1 wherein the line of code is part of a JAVA application.

4. The computer implemented process of claim 1 wherein the line of code is part of a JAVA applet.

5. The computer implemented process of claim 1 wherein the line of code is part of a servlet.

6. An apparatus for migrating a file associated with a line of computer code, the apparatus comprising:
a processor;
a first memory connected to the processor;
a JAR file located in the first memory;
a second memory connected to the processor;
a source code file in the second memory;
an IDE running in the second memory, wherein the IDE is operable to display a help dialog box with information related to a line of code in the source code;
a file updater program in the second memory operable to:
responsive to a help dialog box related to a line of code being activated in the IDE, identify a name and a proper location of a JAR file containing the line of code;
display the name and the proper location of the JAR file in the help dialog box;
determine that the JAR file is missing from the proper location in the second memory;
responsive to determining that the JAR file is missing from the proper location in the second memory, locate an original source of the JAR file in the first memory;
display the contents of the original source of the JAR file; and
place a copy of the JAR file in the proper location in the second memory.

7. The apparatus of claim 6 further comprising a corrupted JAR file in the second memory, and the file updater program in the second memory is further operable to:
determine that the corrupt JAR file in the second memory causes an error;
responsive to determining that the corrupt JAR file causes an error, locate an original source of the JAR file in the first memory; and
replace the corrupt JAR file in the second memory with a copy of the JAR file from the first memory.

8. The apparatus of claim 6 wherein the source code is a JAVA application.

9. The apparatus of claim 6 wherein the source code is a JAVA applet.

10. The apparatus of claim 6 wherein the source code is a servlet.

11. The apparatus of claim 6 wherein the line of code is a JAVA import statement.

12. A computer readable memory containing a plurality of instructions to cause a computer to migrate a file associated with a line of computer code from a first environment to a second environment, the plurality of instructions comprising:
responsive to a help dialog box being opened in an IDE for a line of code in the second environment executing:
a first instruction to identify a name and a proper location in the second environment of a JAR file containing the line of code;
a second instruction to display the name and the proper location in the second environment of the JAR file in the help dialog box;
a third instruction to determine that the JAR file is missing from the proper location in the second environment;
responsive to determining that the JAR file is missing from the proper location in the second environment:
a fourth instruction to locate an original source of the JAR file in the first environment;
a fifth instruction to display the contents of the JAR file from the first environment; and
a sixth instruction to place a copy of the JAR file from the first environment in the proper location in the second environment.

13. The computer readable memory of claim 12 further comprising:
a seventh instruction to determine whether a JAR file in the proper location in the second environment causes an error;
responsive to determining that the JAR file in the proper location in the second environment causes an error;
an eighth instruction to locate an original source of the JAR file in the first environment; and
and a ninth instruction to replace the JAR file in the second environment with a copy of the JAR file from the first environment.

14. The computer readable memory of claim 12 wherein the line of code is part of a JAVA application.

15. The computer readable memory of claim 12 wherein the line of code is part of a JAVA applet.

16. The computer readable memory of claim 12 wherein the line of code is part of a servlet.

17. The computer readable memory of claim 12 wherein the line of code is a JAVA import statement.
